(19) United States
(12) Patent Application Publication
(10) Pub. No.: US 2018/0253968 A1
(43) Pub. Date: Sep. 6, 2018

(54) SYSTEMS AND METHODS FOR TRIGGERING TRAFFIC LIGHT SENSORS

(71) Applicant: Faraday&Future Inc., Gardena, CA (US)

(72) Inventor: Veera Ganesh Yalla, Sunnyvale, CA (US)

(21) Appl. No.: 15/690,158

(22) Filed: Aug. 29, 2017

Related U.S. Application Data
(60) Provisional application No. 62/381,511, filed on Aug. 30, 2016.

(51) Int. Cl. G08G 1/097; G08G 1/005; G05D 1/02

(52) U.S. Cl. CPC G08G 1/097; G05D 1/0212; G08G 1/005

(57) ABSTRACT

Systems and methods can be used for triggering traffic light sensors. A vehicle can detect a condition indicative of a failure of a traffic light to transition (e.g., due to a failure to activate a traffic light sensor) and take action in response. In some examples, the condition can be detected based on the state of the traffic light facing the vehicle and/or the state of one or more traffic lights controlling traffic perpendicular to the vehicle. In some examples, the condition can be detected based on a duration of a state of the traffic lights. In response to detecting the condition, the vehicle can take action. In some examples, the autonomous driving system of the vehicle can automatically adjust the vehicle's position to trigger the sensor. In some examples, the vehicle can notify the driver of the condition. In some examples, the autonomous driving system of the vehicle can reroute the vehicle.

### CROSS-REFERENCE TO RELATED APPLICATIONS

This application claims the benefit of U.S. Provisional Application No. 62/381,511, filed Aug. 30, 2016, the entirety of which is hereby incorporated by reference.

### FIELD OF THE DISCLOSURE

This relates generally to vehicles with autonomous driving systems, and more particularly, to systems and methods for triggering traffic light sensors.

### BACKGROUND OF THE INVENTION

Operation of traffic signals, such as traffic lights, can often be dependent on sensors to detect the presence of a vehicle. For example, the presence of a vehicle may trigger a transition from red to green for the traffic light facing the vehicle. Inductive loop sensors, force sensors, and camera-based sensors are commonly used. Drivers can trigger a transition of a traffic light by stopping the vehicle to activate a traffic light sensor. For vehicles with autonomous driving systems, however, the vehicle may stop without activating the sensor. As a result, the transition of the traffic light may take longer or not occur at all.

### SUMMARY OF THE DISCLOSURE

This relates to systems and methods for triggering traffic light sensors. A vehicle can detect a condition indicative of a failure of a traffic light to transition (e.g., due to a failure to activate a traffic light sensor) and take action in response. In some examples, the condition can be detected based on the state of the traffic light facing the vehicle. In some examples, the condition can be detected based on the state of one or more traffic lights controlling traffic perpendicular to the vehicle. In some examples, the condition can be detected based on a duration of a state of the traffic lights. In response to detecting the condition, the vehicle can take action. In some examples, the autonomous driving system of the vehicle can automatically adjust the vehicle's position to trigger the sensor. In some examples, the vehicle can notify the driver of the condition. In some examples, the autonomous driving system of the vehicle can reroute the vehicle.

### BRIEF DESCRIPTION OF THE DRAWINGS

FIG. 1 illustrates an exemplary system block diagram of a vehicle control system capable of detecting a condition indicative of a failure of a traffic light to transition and taking action in response.

FIG. 2 illustrates an exemplary intersection including various traffic light sensors according to examples of the disclosure.

FIG. 3 illustrates an exemplary process of detecting a failure of a traffic light to transition and taking action in response according to examples of the disclosure.

FIG. 4 illustrates an exemplary process of autonomously moving a vehicle to trigger a traffic light sensor according to examples of the disclosure.

FIG. 5 illustrates an exemplary process of determining a presence and/or a location of a traffic light sensor and taking action in response according to examples of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

This relates to systems and methods for triggering traffic light sensors. A vehicle can detect a condition indicative of a failure of a traffic light to transition (e.g., due to a failure to activate a traffic light sensor) and take action in response. In some examples, the condition can be detected based on the state of the traffic light facing the vehicle. In some examples, the condition can be detected based on the state of one or more traffic lights controlling traffic perpendicular to the vehicle. In some examples, the condition can be detected based on a duration of a state of the traffic lights. In response to detecting the condition, the vehicle can take action. In some examples, the autonomous driving system of the vehicle can automatically adjust the vehicle's position to trigger the sensor. In some examples, the vehicle can notify the driver of the condition. In some examples, the autonomous driving system of the vehicle can reroute the vehicle.

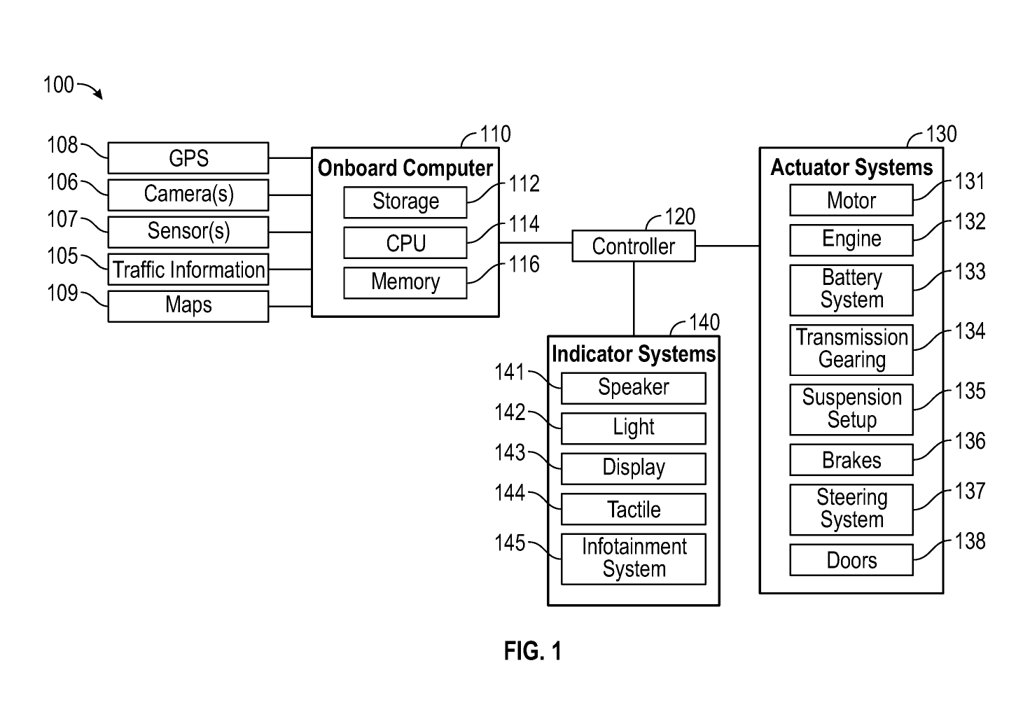

FIG. 1 illustrates an exemplary system block diagram of a vehicle control system capable of detecting a condition indicative of a failure of a traffic light to transition (e.g., because of failure to activate a traffic light sensor) and taking action in response. System 100 can be incorporated into a vehicle, such as a consumer automobile. Other example vehicles that may incorporate the system 100 include, without limitation, airplanes, boats, motorcycles or industrial automobiles. Vehicle control system 100 can include one or more cameras 106 capable of capturing image data (e.g., video data) for determining various characteristics of the vehicle's surroundings. Vehicle control system 100 can also include one or more other sensors 107 (e.g., radar, ultrasonic, LIDAR, etc.) capable of detecting various characteristics of the vehicle's surroundings. For example, cameras 106 and sensors 107 can be used for detecting the presence of objects, such as other vehicles, pedestrians and traffic light sensors. Global Positioning System (GPS) receiver 108 can be capable of determining the location of the vehicle. In some examples, traffic information 105 and maps 109 can be received (e.g., by an antenna) or accessed (e.g., from storage 112 or memory 116), and can be used, for example, for determining automated driving routes. Maps 109 can be high-definition maps, which optionally can include information about light traffic sensors (presence, type and/or location).

Vehicle control system 100 can include an on-board computer 110 coupled to the traffic information 105, cameras 106, sensors 107, GPS receiver 108, and maps 109. On-board computer 110 can be capable of receiving one or more of the traffic information, image data from the cameras, outputs from the sensors 107 and the GPS receiver 108, and maps 109. On-board computer 110 can include storage 112, memory 116, and a processor (central processing unit (CPU)) 114. CPU 114 can execute autonomous driving software stored in storage 112 and/or memory 114. For example, CPU 114 can process some or all of the traffic information, image data, sensor outputs, GPS outputs, and maps, and make driving decisions based thereon. For example, processing can include detecting and tracking objects in the environment, tracking vehicle parameters (e.g., odometry, location), navigation planning, lane selection/change planning, motion planning, determining automated driving commands, etc. CPU 114 (or another processor in vehicle 100) can also process some or all of the traffic information, image data, sensor outputs, GPS outputs, and maps to detect a condition indicative of a failure of a traffic light to transition (e.g., due to a failure to activate a traffic light sensor) and take action based on detecting the condition, as discussed in more detail herein. Additionally, storage 112 and/or memory 116 can store data and instructions for performing the above processing. Storage 112 and/or memory 116 can be any non-transitory computer readable storage medium, such as a solid-state drive, a hard disk drive or a random access memory (RAM) among other possibilities.

The vehicle control system 100 can also include a controller 120 capable of controlling one or more aspects of vehicle operation based on automated driving commands received from the processor. In some examples, the vehicle control system 100 can be connected to (e.g., via controller 120) one or more actuator systems 130 in the vehicle and one or more indicator systems 140 in the vehicle. The one or more actuator systems 130 can include, but are not limited to, a motor 131 or engine 132, battery system 133, transmission gearing 134, suspension setup 135, brakes 136, steering system 137, and door system 138. The vehicle control system 100 can control, via controller 120, one or more of these actuator systems 130 during vehicle operation; for example, to open or close one or more of the doors of the vehicle using the door actuator system 138, to control the vehicle during autonomous driving or parking operations using the motor 131 or engine 132, battery system 133, transmission gearing 134, suspension setup 135, brakes 136 and/or steering system 137, etc. It should be understood that autonomous driving described herein is not limited to fully autonomous driving systems; autonomous driving can include fully or partially autonomous driving, and/or driver assistance systems.

The one or more indicator systems 140 can include, but are not limited to, one or more speakers 141, one or more lights 142 in the vehicle, one or more displays 143 in the vehicle, one or more tactile actuators 144 in the vehicle (e.g., as part of a steering wheel or seat in the vehicle), and one or more infotainment systems 145 (e.g., providing entertainment and/or information to the user). The vehicle control system 100 can control, via controller 120, one or more of these indicator systems 140 to provide indications to a user of the vehicle.

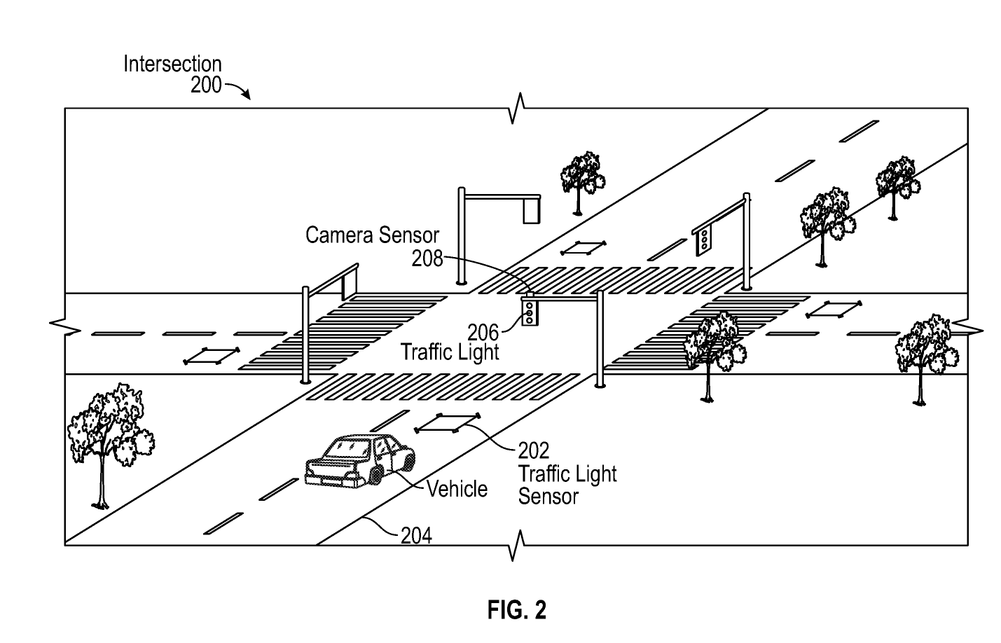

As described herein, intersections can include one or more traffic light sensors, such as inductive loop sensors or camera-based sensors. Activating a traffic light sensor can trigger a transition of a corresponding traffic light. FIG. 2 illustrates an exemplary intersection 200 including various traffic light sensors according to examples of the disclosure. Intersection 200 can include a traffic light sensor 202 embedded in or on road 204 (or otherwise integrated with road 204). The traffic light sensor 202 can be an inductive loop sensor or a force/pressure sensor, for example. Traffic light sensor 202 can be associated with traffic light 206 which controls the traffic for vehicles that pass over traffic light sensor 202. Traffic light sensor 202 can include at least an active state and an inactive state. When vehicle 204 is over traffic light sensor 202, for example, traffic light sensor 202 can transition from the inactivate state to the active state. When the vehicle is no longer over traffic light sensor 202, traffic light sensor 202 can transition from the active state to the inactivate state. The operation of traffic light 206 can be based on the state of the traffic light sensor 202. For example, when traffic light 206 is in a stop state (e.g., red light) and traffic light sensor 202 transitions to the active state, the transition can trigger a change in the state of traffic light 206. For example, traffic light 206 can begin a transition from the stop state to a go state (e.g., green light), either immediately or sooner than the transition would occur without the activation of traffic light sensor 202. Additionally or alternatively, intersection 200 can include a camera-based traffic light sensor to detect the presence of vehicle 204. For example, camera sensor 208 can be integrated with traffic light 206. A transition from a stop state to a go state, as discussed above for example, can be triggered when vehicle 204 is detected by camera sensor 208 (e.g., at a position corresponding to the location of traffic light sensor 202). Intersection 200 can include additional traffic light sensors/cameras sensors for the remaining corresponding traffic lights and sections of road.

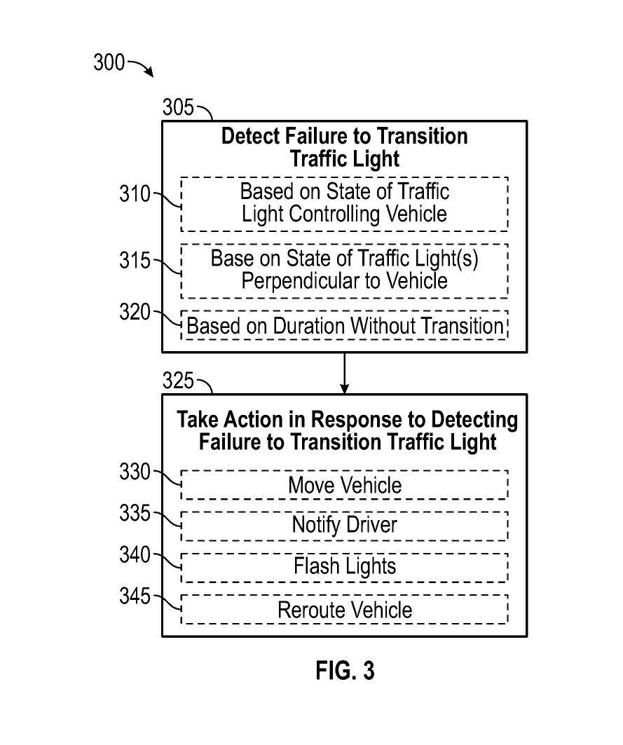

As described herein, when a vehicle stops at intersection 200 without activating traffic light sensor 202, the autonomous driving system can take action. More generally, the autonomous driving system can detect a failure of the traffic light to transition (e.g., due to a failure to activate the traffic light sensor or due to a broken traffic light), and take action in response. FIG. 3 illustrates an exemplary process 300 of detecting a failure of a traffic light to transition and taking action in response according to examples of the disclosure. At 305, the vehicle system (e.g., an autonomous driving system) can detect a failure of the traffic light to transition. In some examples, the detection can be based on the state of the traffic light controlling the vehicle at 310. Additionally or alternatively, in some examples, the detection can be based on the state of the traffic light(s) controlling traffic perpendicular to the vehicle at 315. Additionally or alternatively, in some examples, the detection can be based on a duration, without transition, of a state of the traffic light at 320. Detection of the state of the traffic light(s) can be based on images captured by a forward-facing vehicle camera (e.g., one of cameras 106), for example. In some examples, the system can detect that the traffic light controlling the vehicle remains in a stop state (e.g., red light) for more than a first threshold amount of time. In some examples example, the system can detect that the traffic light controlling the vehicle and those traffic lights controlling perpendicular traffic are in the stop state (e.g., red) for more than a second threshold amount of time. The first and second thresholds can be the same duration or a different duration. In some examples, the second threshold can be shorter than the first threshold (e.g., because properly operating traffic lights do not show the stop state in all directions). The thresholds can be fixed duration thresholds (e.g., 15 seconds, 5 seconds, etc.), or the thresholds can be of variable durations (e.g., based on the intersection, type of intersection, time of day, etc.). For example, information about the timing for the intersection can be included in a high definition map (e.g., map 109), and can be used to determine the threshold amount of time.

At 325, the system can take action in response to detecting a failure of the traffic light to transition. In some examples, the response can include moving the vehicle to trigger the traffic light sensor at 330. For example, the system can cause the vehicle to inch forward to activate the traffic light sensor. Additionally or alternatively, the response can include notifying the driver at 335. The notification can be audio, visual, haptic, or any type of suitable notification (or a combination thereof). The notification can, for example, let the driver know about possible movement or advise the driver of the detected condition so that the driver can take control. Additionally or alternatively, the response can include flashing one or more vehicle lights at 340. For example, flashing lights may notify other vehicles or pedestrians about the movement of the vehicle, or flashing lights may trigger a camera-based or optical-based traffic light sensor. Additionally or alternatively, the response can include rerouting the vehicle at 345. For example, if making a right turn is permissible during a stop condition (e.g., right turn on red), the autonomous vehicle can make a right turn (instead of waiting for the traffic light to transition before a left turn or continuing forward without a turn) and update the autonomous navigation accordingly. In some examples, the vehicle can avoid the intersection in future navigation (and/or possibly notify other vehicles or drivers to avoid the intersection). In some examples, the vehicle can ignore the stop state of the traffic signal (e.g., run the red light) when no pedestrians or vehicles (or other objects) are present (e.g., in rural areas where such practice may be commonly accepted).

Although described herein as being performed by an autonomous driving system, the process of detecting of a failure to transition the traffic light and taking action in response can also be performed by a vehicle without an autonomous driving capability (e.g., without performing actions that require autonomous driving to move the vehicle).

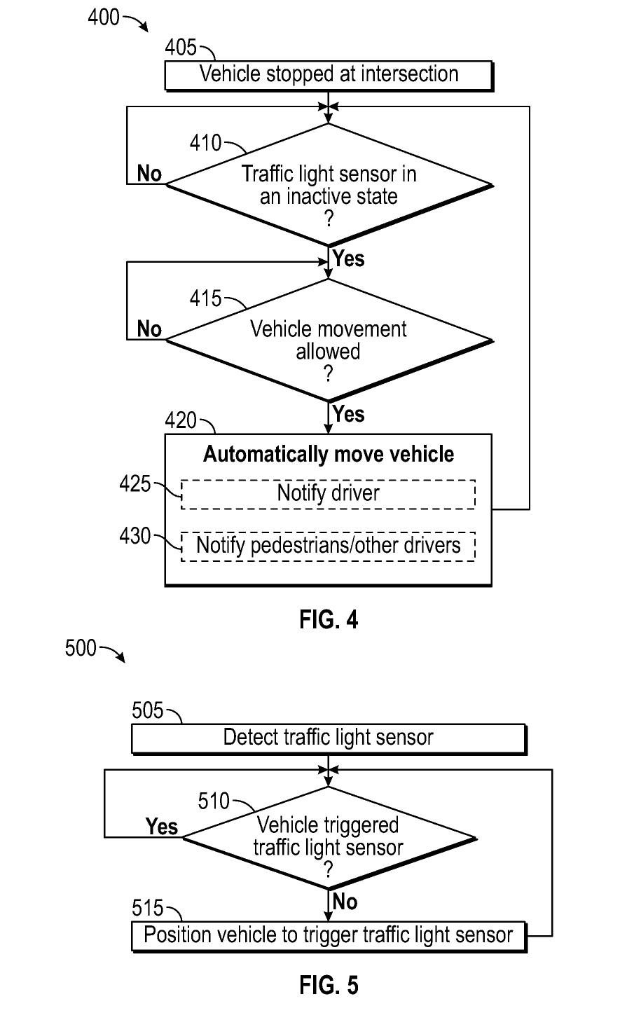

As discussed herein, in autonomous driving mode, the vehicle may stop behind a limit line (e.g., a crosswalk or intersection) and may fail to trigger a traffic light sensor. In some examples, the autonomous driving system of the vehicle can move the vehicle so as to trigger the traffic light sensor. FIG. 4 illustrates an exemplary process 400 of autonomously moving a vehicle to trigger a traffic light sensor according to examples of the disclosure. Process 400 can begin when a vehicle is stopped at an intersection. At 410, the system can determine whether the traffic light sensor is in an inactive state. The system can determine that the traffic light sensor is in the inactive state when the traffic light fails to transition (e.g., as discussed above with respect to FIG. 3). At 415, when the traffic light sensor is determined to be in the inactive state, the system can determine whether movement by the vehicle is allowed. For example, the system can prevent movement when vehicles, pedestrians or other objects are detected (e.g., within a threshold distance) of the vehicle. In some examples, the system can prevent movement when the vehicle in within a threshold distance of a limit line (e.g., a crosswalk, intersection, etc.). In some examples, the system can prevent movement when the vehicle has moved a threshold number of times in an attempt to trigger the traffic light sensor or moved a threshold distance. At 420, when vehicle movement is allowed, the system can automatically move the vehicle. In some examples, the vehicle can be moved forward by a fixed distance (e.g., 6 inches, 1 foot, etc.). In some examples, the vehicle can be moved forward by a variable distance (e.g., depending on the total distance allowed under the current conditions). In some examples, the system can also notify the driver about the movement before or during the movement at 425. In some examples, the system can notify pedestrians or other drivers at 430. For example, the vehicle may project lights (possibly including text) and/or generate sound indicating the movement and/or the amount of movement. Process 400 can provide for safe automatic triggering of a traffic light sensor in a driver-friendly manner.

The system can iteratively determine whether the traffic light sensor is inactive, determine whether vehicle movement is allowed, and automatically move the vehicle. For example, after moving the vehicle forward, the system can again determine whether the traffic light sensor is in the inactive state at 410. In some examples, the subsequent determinations of the state of the traffic light sensor can be the same as the first determination. In some examples, the subsequent determinations of the state of the traffic light sensor can be different from the first determination. For example, the first determination can be based on a first duration of time (e.g., red light without transitioning for a first duration), whereas the subsequent determinations can be based on a second duration of time. The second duration of time can be different from the first duration of time, and in some examples, the second duration of time can be shorter than the first duration of time. When the traffic light sensor is in the inactive state in subsequent determinations, the system can again determine whether vehicle movement is allowed and automatically move the vehicle in a similar manner to the above description.

In some examples, process 400 can terminate after the traffic light sensor is determined to be in an active state, after a threshold number of movements, or after a threshold timeout period passes. In some examples, process 400 can terminate when the system detects an indication that the state of the traffic light will change (e.g., a change in the state of a pedestrian crossing signal perpendicular to the vehicle).

Although forward movement is discussed above, in some examples, the movement may be in a different direction. For example, the vehicle may move backward if the traffic light sensors are determined to be behind the vehicle (or if forward motion is prohibited, but backward motion is permitted). In some examples, the vehicle may move forward at an angle and/or with different angles during movements of different iterations of process 400 in an attempt to trigger the traffic light sensor that may also be laterally offset from the vehicle position. When lateral movement is performed, the determination, at 415, of whether movement is allowed can include considering a lateral movement threshold or lateral lane lines as well.

In some examples, process 400 can be performed only when the vehicle is the first vehicle stopped at the intersection. For example, in such circumstances, other drivers/vehicles may not be able to trigger the traffic light sensor and may expect the vehicle in the first position to do so. Additionally, when another vehicle is stopped at the intersection in front of the vehicle performing process 400, the other vehicle may be in a better position to trigger the traffic light sensor. However, it should be understood that, in some examples, process 400 can be performed irrespective of the vehicle's position relative to the intersection or the presence of other vehicles. Additionally, in some examples, process 400 can be performed or not performed based on information from high definition maps (e.g., map 109). For example, high definition maps may include information about the presence of traffic light sensors. The system can forgo process 400 when no traffic light sensors are included in the map at the intersection, and perform process 400 when traffic light sensors are included in the map at the intersection. It should be understood that process 300 can also be dependent on various conditions including the position of the vehicle, the presence of a traffic light sensor, the presence of vehicles or pedestrians in the environment, whether movement is allowed, etc.

It should also be understood that various actions, such as those described in process 300, can also be performed iteratively and/or in combination. For example, the system can first attempt to move the vehicle to trigger the sensor (e.g., according to process 400), but when the attempt fails, the system can notify the driver and/or reroute the vehicle. In some examples, the system can notify the driver before automatically rerouting. In some examples, the lights can be flashed along with movement of the vehicle or after a first iteration of movement according to process 400 when the traffic light sensor is not triggered by the movement. It should be understood that these combinations/iterations are exemplary, and additional combinations or interactions between the different actions are anticipated and within the scope of the disclosure. In some examples, the action(s) or combination of actions can be dynamically selected based on various conditions (e.g., vehicle position, information regarding the presence or absence of traffic light sensors, the type of traffic light sensor, the presence of vehicles or pedestrians, user preferences, etc.). For example, rerouting the car may not be desirable when the vehicle is in traffic, moving the car to trigger the traffic light sensor may not be desirable when heavy pedestrian traffic is detected or when no traffic light sensor present, and rerouting may not be desirable during heavy traffic times. It should be understood that these conditions are exemplary, and additional alterations in the response according to various conditions are within the scope of the disclosure.

In some examples, an autonomous driving system can determine a presence and/or a location of a traffic light sensor and autonomously take action in response. FIG. 5 illustrates an exemplary process 500 of determining a presence and/or a location of a traffic light sensor and taking action in response according to examples of the disclosure. At 505, the system (e.g., an autonomous driving system) can detect a traffic light sensor (e.g., while the vehicle approaches and is proximate to an intersection). In some examples, the system can detect the presence and/or location of a traffic light sensor based on information from a map (e.g., maps 109). In some examples, when no traffic light sensor is indicated by the map, process 500 can be terminated or not initiated. In some examples, the system can detect the presence and/or location of a traffic light sensor using cameras, radar, LIDAR, or any other suitable vehicle sensor. For example, a traffic light sensor can be detected based on images from the camera or LIDAR (e.g., configured to capture images of the road). The images can be processed to identify the inductive loop sensors (e.g., based on the shape of the sensor itself or the grooves cut into the road during the installation of the inductive loop sensors). At 510, the system can determine whether the traffic light sensor is triggered. In some examples, whether the traffic light sensor is triggered is based on the location of the vehicle (e.g., known via GPS 108) and the location of the traffic light sensor detected at 510. When the location of the vehicle and the location of the traffic light sensor are within a threshold of each other, the traffic light sensor can be determined to be triggered. When the traffic light sensor is not determined to be triggered, at 515, the vehicle can be automatically positioned (or repositioned) to trigger the traffic light sensor. In some examples, the determination of whether the traffic light sensor is triggered and the positioning the vehicle can be iterative. In some examples, when the traffic light sensor is determined to be triggered, the vehicle can stop moving and/or process 500 can be terminated.

In some examples, the determination of whether the traffic light sensor is triggered can be performed while the vehicle is in motion, so as to determine an initial stopping position for the vehicle. Positioning the vehicle can include causing the vehicle to come to a stop such that the traffic light sensor is triggered (after taking into account other overriding heuristics or logic used to determine stopping position, such as position relative to the intersection, other vehicles, pedestrians, etc.). In some examples, the determination of whether the traffic light sensor is triggered can be performed after the vehicle comes to a stop, so as to reposition the vehicle to trigger the traffic light sensor. In such a case, positioning the vehicle can include moving the vehicle to trigger a sensor (e.g., forward, backward, etc.). In some examples, the determination of whether a traffic light sensor is triggered and reposition the vehicle when stationary can be performed according to processes 300 and/or 400. Additionally, the knowledge about the location of the detected traffic light sensor can be used to guide the movement of the vehicle according to processes 300 and/or 400. In some examples, the determination of whether the traffic light sensor is triggered and positioning the vehicle can be performed under both motion and no motion conditions. The vehicle can attempt to stop in a position to trigger the traffic light sensor, but when the traffic light sensor is not triggered, the system can determine whether to reposition the vehicle.

In some examples, the system can forgo process 500 under various conditions. For example, when other vehicles are detected stopped at or coming to a stop at the intersection in front of the vehicle, the system can forgo process 500.

Therefore, according to the above, some examples of the disclosure are directed to a method. The method can comprise: detecting a failure of a traffic light facing a vehicle to transition; and in response to detecting the failure of the traffic light to transition, automatically causing the vehicle to perform an action. Additionally or alternatively to one or more of the examples disclosed above, in some examples, detecting the failure of the traffic light to transition can comprise detecting a stop state of the traffic light without transition for a threshold duration of time. Additionally or alternatively to one or more of the examples disclosed above, in some examples, detecting the failure of the traffic light to transition can further comprise detecting a stop state of one or more traffic lights controlling traffic perpendicular to the vehicle while detecting the stop state of the traffic light facing the vehicle. Additionally or alternatively to one or more of the examples disclosed above, in some examples, the action can comprise moving the vehicle to trigger a traffic light sensor. Additionally or alternatively to one or more of the examples disclosed above, in some examples, the action can comprise notifying a driver of the vehicle of the failure of the traffic light facing the vehicle to transition. Some examples of the disclosure are directed to a non-transitory computer-readable medium. The non-transitory computer-readable medium can include instructions, which when executed by one or more processors, can cause the one or more processors to perform any of the above methods. Some examples of the disclosure are directed to a vehicle. The vehicle can comprise: one or more processors; and a non-transitory computer-readable medium including instructions, which when executed by the one or more processors, cause the one or more processors to perform any of the above methods.

Some examples of the disclosure are directed to a method. The method can comprise: determining a state of a traffic light sensor; determining, when the detected state of the traffic light sensor is an inactive state, whether vehicle movement is allowed; and automatically moving the vehicle in accordance with a determination that vehicle movement is allowed. Additionally or alternatively to one or more of the examples disclosed above, in some examples, determining the state of the traffic light sensor is the inactive state can comprise detecting a stop state of a traffic light corresponding to the traffic light sensor for a first threshold duration of time. Additionally or alternatively to one or more of the examples disclosed above, in some examples, determining the state of the traffic light sensor is the inactive state can comprise detecting a stop state of a traffic light corresponding to the traffic light sensor and a stop state of one or more traffic lights controlling traffic perpendicular to the vehicle for a first duration of time. Additionally or alternatively to one or more of the examples disclosed above, in some examples, determining whether the vehicle movement is allowed can comprise detecting the presence of another vehicle in front of the vehicle; and in accordance with a determination that the another vehicle is a threshold distance from the from the vehicle, determining that vehicle movement is allowed. Additionally or alternatively to one or more of the examples disclosed above, in some examples, determining whether the vehicle movement is allowed can comprise: detecting the presence of a pedestrian in front of the vehicle; and in accordance with a determination that the pedestrian is a threshold distance from the from the vehicle, determining that vehicle movement is allowed. Additionally or alternatively to one or more of the examples disclosed above, in some examples, determining whether the vehicle movement is allowed can comprise detecting a limit line in front of the vehicle; and in accordance with a determination that the limit line is a threshold distance from the from the vehicle, determining that vehicle movement is allowed. Additionally or alternatively to one or more of the examples disclosed above, in some examples, automatically moving the vehicle comprises moving the vehicle forward a first distance in accordance with the determination that vehicle movement is allowed. Additionally or alternatively to one or more of the examples disclosed above, in some examples, the method can further comprise: in response to automatically moving the vehicle: re-determining the state of the traffic light sensor; re-determining, when the re-determined state of the traffic light sensor is the inactive state, whether further vehicle movement is allowed; and automatically further moving the vehicle in accordance with a determination that further vehicle movement is allowed. Additionally or alternatively to one or more of the examples disclosed above, in some examples, re-determining the state of the traffic light sensor can comprise detecting a stop state of a traffic light corresponding to the traffic light sensor for a second threshold duration of time. The second threshold duration of time can be different than a first threshold duration of time. Additionally or alternatively to one or more of the examples disclosed above, in some examples, the method can further comprise: notifying a driver of the vehicle of the vehicle movement before or during the vehicle movement. Additionally or alternatively to one or more of the examples disclosed above, in some examples, the method can further comprise notifying a pedestrian or driver of another vehicle of the vehicle movement before or during the vehicle movement. Some examples of the disclosure are directed to a non-transitory computer-readable medium. The non-transitory computer-readable medium can include instructions, which when executed by one or more processors, can cause the one or more processors to perform any of the above methods. Some examples of the disclosure are directed to a vehicle. The vehicle can comprise: one or more processors; and a non-transitory computer-readable medium including instructions, which when executed by the one or more processors, cause the one or more processors to perform any of the above methods.

Although examples of this disclosure have been fully described with reference to the accompanying drawings, it is to be noted that various changes and modifications will become apparent to those skilled in the art. Such changes and modifications are to be understood as being included within the scope of examples of this disclosure as defined by the appended claims.

1. A method comprising:
detecting a failure of a traffic light facing a vehicle to transition; and
in response to detecting the failure of the traffic light to transition, automatically causing the vehicle to perform an action.

2. The method of claim 1, wherein detecting the failure of the traffic light to transition comprises:
detecting a stop state of the traffic light without transition for a threshold duration of time.

3. The method of claim 2, wherein detecting the failure of the traffic light to transition further comprises:
detecting a stop state of one or more traffic lights controlling traffic perpendicular to the vehicle while detecting the stop state of the traffic light facing the vehicle.

4. The method of claim 1, wherein the action comprises moving the vehicle to trigger a traffic light sensor.

5. The method of claim 1, wherein the action comprises notifying a driver of the vehicle of the failure of the traffic light facing the vehicle to transition.

6. The method of claim 1, wherein the action comprises rerouting the vehicle.

7. A method comprising:
determining a state of a traffic light sensor;
determining, when the detected state of the traffic light sensor is an inactive state, whether vehicle movement is allowed; and
automatically moving the vehicle in accordance with a determination that vehicle movement is allowed.

8. The method of claim 7, wherein determining the state of the traffic light sensor is the inactive state comprises:
detecting a stop state of a traffic light corresponding to the traffic light sensor for a first threshold duration of time.

9. The method of claim 7, wherein determining the state of the traffic light sensor is the inactive state comprises:
detecting a stop state of a traffic light corresponding to the traffic light sensor and a stop state of one or more traffic lights controlling traffic perpendicular to the vehicle for a first duration of time.

10. The method of claim 7, wherein determining whether the vehicle movement is allowed comprises:
detecting the presence of another vehicle in front of the vehicle; and
in accordance with a determination that the another vehicle is a threshold distance from the from the vehicle, determining that vehicle movement is allowed.

11. The method of claim 7, wherein determining whether the vehicle movement is allowed comprises:
detecting the presence of a pedestrian in front of the vehicle; and
in accordance with a determination that the pedestrian is a threshold distance from the from the vehicle, determining that vehicle movement is allowed.

12. The method of claim 7, wherein determining whether the vehicle movement is allowed comprises:
detecting a limit line in front of the vehicle; and
in accordance with a determination that the limit line is a threshold distance from the from the vehicle, determining that vehicle movement is allowed.

13. The method of claim 7, wherein automatically moving the vehicle comprises:
moving the vehicle forward a first distance in accordance with the determination that vehicle movement is allowed.

14. The method of claim 13, further comprising:
in response to automatically moving the vehicle:
re-determining the state of the traffic light sensor;
re-determining, when the re-determined state of the traffic light sensor is the inactive state, whether further vehicle movement is allowed; and
automatically further moving the vehicle in accordance with a determination that further vehicle movement is allowed.

16. The method of claim 14, wherein re-determining the state of the traffic light sensor comprises:
detecting a stop state of a traffic light corresponding to the traffic light sensor for a second threshold duration of time, wherein the second threshold duration of time is different than a first threshold duration of time.

17. The method of claim 7, further comprising:
notifying a driver of the vehicle of the vehicle movement before or during the vehicle movement.

18. The method of claim 7, further comprising:
notifying a pedestrian or driver of another vehicle of the vehicle movement before or during the vehicle movement.

19. A vehicle comprising:
one or more processors;
memory;
a sensory, wherein the sensor is configured to detect a failure of a traffic light to transition, wherein the traffic light is facing the vehicle; and
in response to the failure of the traffic light to transition, automatically causing the vehicle to perform an action.
